(19) United States
(12) Patent Application Publication
(10) Pub. No.: US 2026/0305876 A1
(43) Pub. Date: Oct. 8, 2026

(54) EGG PROCESSING APPARATUS FOR ORIENTING EGGS AND SUBJECTING EGGS TO IMPACT

(71) Applicant: TOP UNION TECHNOLOGY CO., LTD., Taoyuan City (TW)

(72) Inventor: Jui-Chang Chen, Taoyuan City (TW)

(73) Assignee: TOP UNION TECHNOLOGY CO., LTD., Taoyuan City (TW)

(21) Appl. No.: 19/272,999

(22) Filed: Jul. 17, 2025

(30) Foreign Application Priority Data
Apr. 8, 2025 (TW) 114203459

(51) Int. Cl. A47J 43/14; B65G 15/00

(52) U.S. Cl. CPC A47J 43/145; B65G 15/00; B65G 2201/0208

(57) ABSTRACT

An egg processing apparatus includes a machine body having an egg accommodating area and at least one dividing area forward of the egg accommodating area and for receiving at least one egg in succession; conveying rollers in the dividing area and for driving the egg to rotate and move along a direction toward its smaller end; at least one orienting portion forward of the dividing area and provided therein with a fall space; and at least one impact portion. The smaller end of an egg in the orienting portion contacts and is hindered by the orienting portion’s inner wall surface, and egg position is adjusted to a vertical orientation with its larger end facing down. The egg passes through the fall space and hits the impact portion, cracking its eggshell. The egg processing apparatus fulfills automatic egg orientation and eggshell cracking, increasing egg processing efficiency and automation level.

### CROSS-REFERENCE TO RELATED PATENT APPLICATION

This non-provisional application claims priority to and the benefit of, under 35 U.S.C. § 119(a), Taiwan Patent Application No. 114203459, filed Apr. 8, 2025 in Taiwan. The entire content of the above identified application is incorporated herein by reference.

### FIELD

The present disclosure relates to an egg processing apparatus, and more particularly to an egg processing apparatus that orients at least one egg so that at least one egg fall with its larger ends facing down and cracked automatically by impact through gravitational acceleration of the falling egg(s).

### BACKGROUND

Generally, the internal structure of a chicken egg can be divided, sequentially outward from the center, into a yolk, egg white, egg membranes, and an air cell, which is located at the larger end of the chicken egg. When a chicken egg is being cooked, the air in the air cell is heated and expands and may therefore crack, if not burst, the eggshell. The crack or burst will cause the egg white to leak out such that the appearance of the cooked chicken egg is compromised. In view of this, it is common practice for egg processing plants, restaurants, or other facilities that cook and sell chicken eggs in shell to manually and gently strike the larger end of each chicken egg to be cooked, the objective being to slightly crack the eggshell at the larger end of the chicken egg, allowing the air in the air cell to escape through the crack, so that the look of the chicken egg is not impaired by leaked egg white once the chicken egg is cooked. The crack also makes it easier for the flavored liquid in which the chicken egg is stewed to seep into the chicken egg, thus shortening the total time required to cook or process the chicken egg.

However, the step of manually striking the larger end of each chicken egg not only is time-consuming, but also incurs a high labor cost. More importantly, the manual striking force is difficult to control and depends entirely on the operator’s experience. If the striking force is too weak, the operator will have to strike several times. If the striking force is too strong, the egg white will flow out immediately after the strike, causing an increase in fraction defective. In view of this, Applicant had invented a device for subjecting eggs to impact, which has been awarded with Taiwan Patent No. I693912. Nevertheless, there is still room for improvement in its overall structure. Therefore, one of the issues to be addressed in the present disclosure is how to improve such a design.

### SUMMARY

Based on years of extensive practical experience, and as a result of longtime labored research and experiment, an egg processing apparatus for orienting at least one egg and subjecting at least one egg to impact is provided in the present disclosure, so as to effectively address the above-referenced issues.

Certain aspects of the present disclosure are directed to an egg processing apparatus for orienting at least one egg and subjecting at least one egg to impact. The egg processing apparatus includes a machine body, a plurality of conveying rollers, at least one orienting portion and at least one impact portion. The machine body has an egg accommodating area and at least one dividing area located forward of the egg accommodating area. Each of the dividing areas is configured to receive at least one egg in succession from the egg accommodating area. The plurality of conveying rollers are located in the at least one dividing area, arranged at intervals along a rear-to-front direction, and configured to: convey the at least one egg from a rear-side portion of the at least one dividing area to a front-side portion of the at least one dividing area; and spin to drive the at least one egg in the at least one dividing area to rotate and to move along a direction toward a smaller end of the at least one egg. The at least one orienting portion is located forward of the at least one dividing area, provided therein with a fall space, and configured to, through the inner wall surface of the at least one orienting portion, contact and hinder the smaller end of the at least one egg in the at least one orienting portion, and adjust the position of the at least one egg to a vertical orientation with its larger end facing down when the at least one egg passes through the fall space. The at least one impact portion is located below a corresponding one of the at least one orienting portion, corresponds to the fall space, and is configured to be hit by the larger end of the at least one egg and crack an eggshell at the larger end of the at least one egg. Accordingly, the egg processing apparatus fulfills automatic egg orientation and eggshell cracking, thereby increasing the processing and/or pretreatment efficiency of eggs and automation.

In certain embodiments, the at least one dividing area is a plurality of dividing areas, and each two adjacent ones of the dividing areas are provided therebetween with at least one dividing wall.

In certain embodiments, the length of the entrance of each of the at least one dividing area in the transverse direction is less than the total length of two adjacent eggs in the transverse orientation.

In certain embodiments, the entirety or at least the inner surface of the at least one orienting portion is made of a plastic material with a high coefficient of friction, and the plastic material has a coefficient of static friction equal to or higher than 0.6 on the outer surface of the at least one egg.

In certain embodiments, the at least one impact portion is made of a metal material.

In certain embodiments, the top of the cross-sectional shape of the fall space is wider than the bottom of the cross-sectional shape.

In certain embodiments, the length of the narrowest portion of the cross-sectional shape in the transverse direction is less than the length of each of the at least one egg.

In certain embodiments, the egg processing apparatus further includes at least one egg removing portion, and the at least one egg removing portion is located forward of the at least one impact portion and configured to move the at least one egg away from the at least one impact portion.

In certain embodiments, the egg removing portion includes a rotating shaft and at least one pushing member, and the at least one pushing member is directly or indirectly provided on the periphery, and around the circumference, of the rotating shaft, and is configured to rotate along with the rotating shaft to move into a space above the at least one impact portion and push the at least one egg out of its position on the at least one impact portion.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective view of an egg processing apparatus according to certain embodiments in the present disclosure.

FIG. 2 is top view of the egg processing apparatus, shown with a cover omitted, according to certain embodiments in the present disclosure.

FIG. 3 is a cross-section view of the egg processing apparatus according to certain embodiments in the present disclosure.

FIG. 4 is a schematic diagram showing that a conveying roller spins to drive an egg into displacement according to certain embodiments in the present disclosure.

FIG. 5 is a front view of a part of the egg processing apparatus according to certain embodiments in the present disclosure.

FIG. 6 is a perspective cross-section view of a part of the egg processing apparatus according to certain embodiments in the present disclosure.

FIG. 7 is a perspective cross-section view of the part of the egg processing apparatus shown in FIG. 6, omitting an egg removing portion therein, according to certain embodiments in the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The accompanying drawings are schematic and may not have been drawn to scale. The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, materials, objects, or the like, which are for distinguishing one component/material/object from another one only, and are not intended to, nor should be construed to impose any substantive limitations on the components, materials, objects, or the like. Directional terms (e.g., “front”, “rear”, “left”, “right”, “upper/top” and/or “lower/bottom”) are explanatory only and are not intended to be restrictive of the scope of the present disclosure.

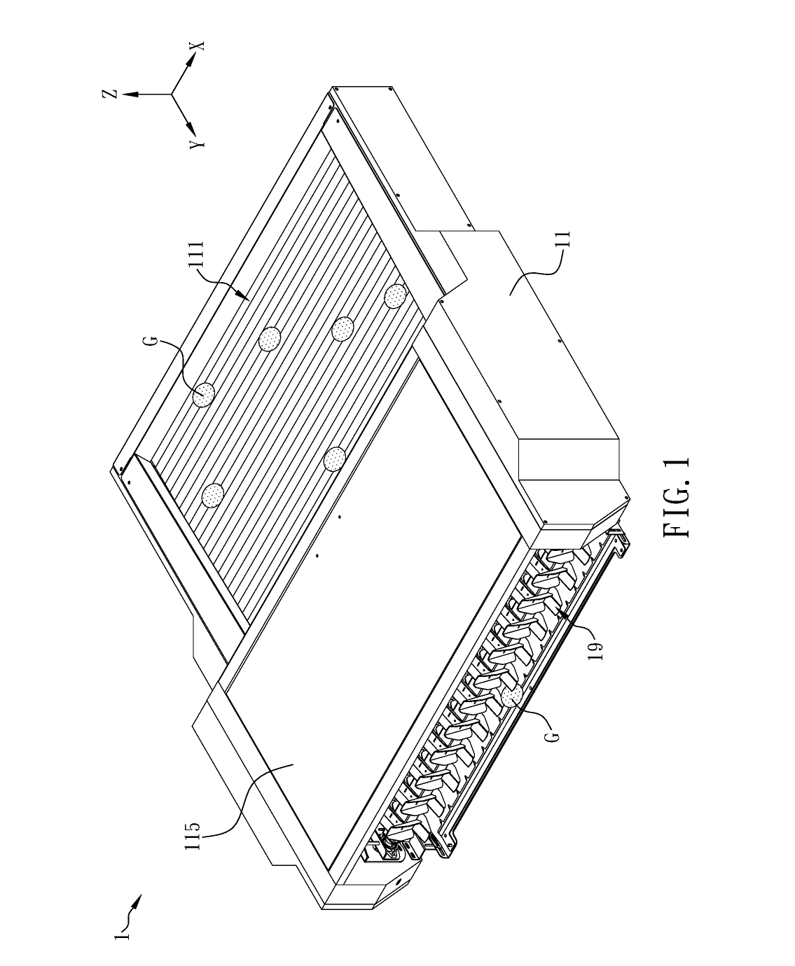

Certain aspects of the present disclosure are directed to an egg processing apparatus for orienting at least one egg and subjecting at least one egg to impact. To facilitate description of component features and relative positional relationship, the spatial configuration of the components as used in the present disclosure is defined by three axes that are perpendicular to one another, namely a transverse axis (the X axis), a longitudinal axis (the Y axis), and a horizontal axis (the Z axis). Generally, unless the context clearly dictates otherwise, the transverse axis (the X axis) refers to the direction extending between the right and left sides, wherein the upper left of FIG. 1 is defined as facing the left side of a component, and the lower right of FIG. 1 as facing the right side of a component; the longitudinal axis (the Y axis) refers to the direction extending between the front and rear sides, wherein the lower left of FIG. 1 is defined as facing the front side of a component, and the upper right of FIG. 1 as facing the rear side of a component; and the horizontal axis (the Z axis) refers to the direction extending between the top and bottom sides, wherein the top (upper) side of FIG. 1 is defined as facing the top side of a component, and the bottom side of FIG. 1 as facing the bottom (lower) side of a component.

Referring to FIGS. 1-3, in certain embodiments, the egg processing apparatus 1 includes a machine body 11, a plurality of conveying rollers 13, a plurality of orienting portions 15, and a plurality of impact portions 17. However, according to actual product requirements, each of the number of the orienting portion(s) 15 and the number of the impact portion(s) 17 can be one, that is, not being limited to more than one, so as to improve application flexibility. Further, the machine body 11 can be divided into an egg accommodating area 111 and a plurality of dividing areas 113. The egg accommodating area 111 is where a plurality of eggs G (e.g., chicken eggs, duck eggs, or goose eggs) can be placed, and the eggs G in the accommodating area 111 are generally in a transverse orientation (i.e., with each of the smaller end and the larger end of each egg G pointing to one or the other of the left and right sides of the egg accommodating area 111) while being conveyed forward of the egg accommodating area 111. In certain embodiments, the egg accommodating area 111 is provided with a conveying device 1111 (e.g., a conveyor belt) for conveying the eggs G forward of the egg accommodating area 111. However, the present disclosure is not limited thereto, and in certain embodiments, the bottom side of the accommodating area 111 can be tilted in such a way that the rear end of the bottom side is higher than the front end of the bottom side to allow the eggs G to roll forward of the egg accommodating area 111 naturally due to the force of gravity. In certain embodiments, an external device (such as a robotic arm) is used to allow the eggs G to roll forward of the egg accommodating area 111.

With continued reference to FIGS. 1-3, the dividing areas 113 are located forward of the egg accommodating area 111 and are arranged along the transverse direction (X axis). In certain embodiments, the dividing areas 113 can be shielded with a cover 115 (as shown in FIG. 1); however, the present disclosure is not limited thereto. The direction in which the eggs G enter and exit the dividing areas 113 is such that the rear side of each dividing area 113 is defined as the entrance for receiving eggs G from the egg accommodating area 111, and that the front side of each dividing area 113 is defined as the exit by which eggs G leave the dividing area 113. The length of the entrance of each dividing area 113 in the left-right direction (i.e., the length in the transverse direction) is less than the total length of two adjacent eggs G in the transverse orientation; therefore, each dividing area 113 allows entry of only one egg G at a time. In other words, each dividing area 113 can receive eggs G from the egg accommodating area 111 only one after another. This reduces the risk that two eggs G may push, or collide with, each other and thus damage their eggshells during the conveying process as discussed infra. In certain embodiments, each two adjacent dividing areas 113 are provided therebetween with at least one dividing wall 1131 to prevent the egg(s) G in each dividing area 113 from rolling into an/the adjacent dividing area 113 by accident. However, the present disclosure is not limited thereto, and in certain embodiments, based on actual needs, only one dividing wall 1131 is provided. In certain embodiments, the dividing wall(s) 1131 can be dispensed with if the length of each dividing area 113 in the front-rear direction is relatively short and hence makes it difficult for the egg(s) G in each dividing area 113 to roll into an/the adjacent dividing area 113 by accident. It should be pointed out that the “egg accommodating area 111” and the “dividing areas 113” are not necessarily distinguished by the presence or absence of the conveying device 1111. Rather, the dividing areas 113 are areas where the eggs G in the egg accommodating area 111 begin to form queues, i.e., to move in succession in separate lines, due to an external force or the effect of an external object.

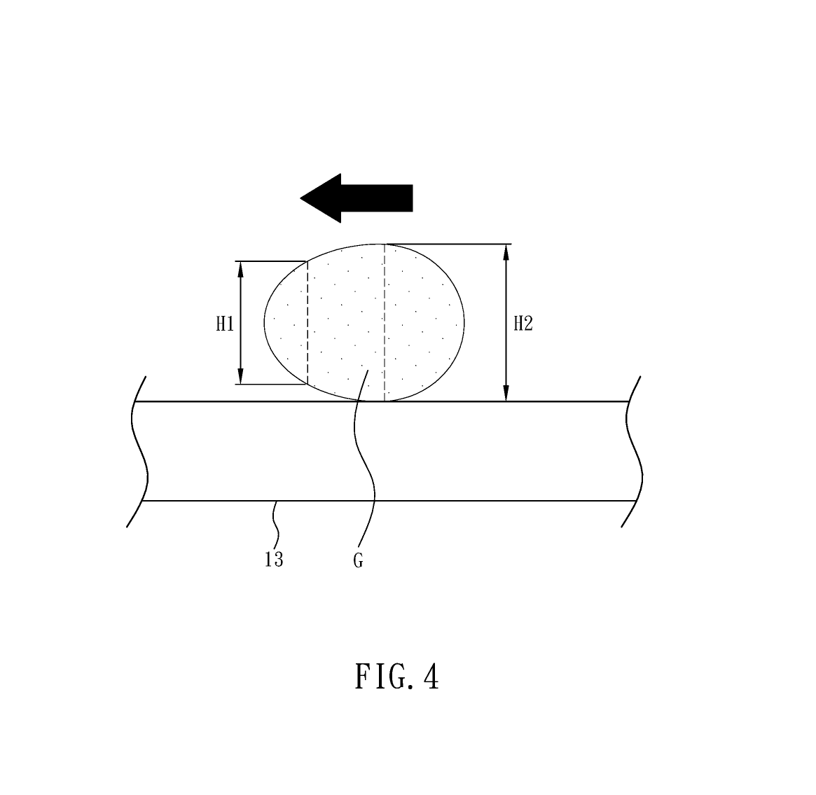

With continued reference to FIGS. 1-3, the conveying rollers 13 are located in the dividing areas 113 and are arranged at intervals along a rear-to-front direction. In certain embodiments, all the dividing areas 113 share the same conveying rollers 13; however, the present disclosure is not limited thereto. The conveying rollers 13 are configured to spin and to convey eggs G from a rear-side portion (i.e., the entrance) of each dividing area 113 to a front-side portion (i.e., the exit) of the dividing area 113. When an egg G enters a dividing area 113, the egg G is driven to rotate (i.e., roll) and to displace along the conveying direction (e.g., forward) by the spinning of the conveying rollers 13. When it comes to the driving method of the conveying rollers 13, all the conveying rollers 13 can be brought into contact with a conveyor belt that drives the conveying rollers 13 to spin passively. In certain embodiments, the conveying rollers 13 can spin actively by means of such external driving mechanisms as gears, chains, and motors. That is to say, the driving method of the conveying rollers 13 may vary, as long as the conveying rollers 13 can spin and are sufficient to drive the eggs G into displacement as well as a rolling motion. Further, referring to FIG. 4, each egg G is in the shape of an asymmetric ellipsoid, with the diameter H1 of the smaller end of the egg G being less than the diameter H2 of the larger end of the egg G. Moreover, while an egg G is spinning, the contact rolling radius (i.e., the rolling circumference radius) of the egg G changes with angle of the axis about which the egg G spins, such that the egg G is slightly yet continuously shifted in position in a sliding manner and is thus gradually moved along the direction toward its smaller end (i.e., in the direction indicated by the thick arrow in FIG. 4).

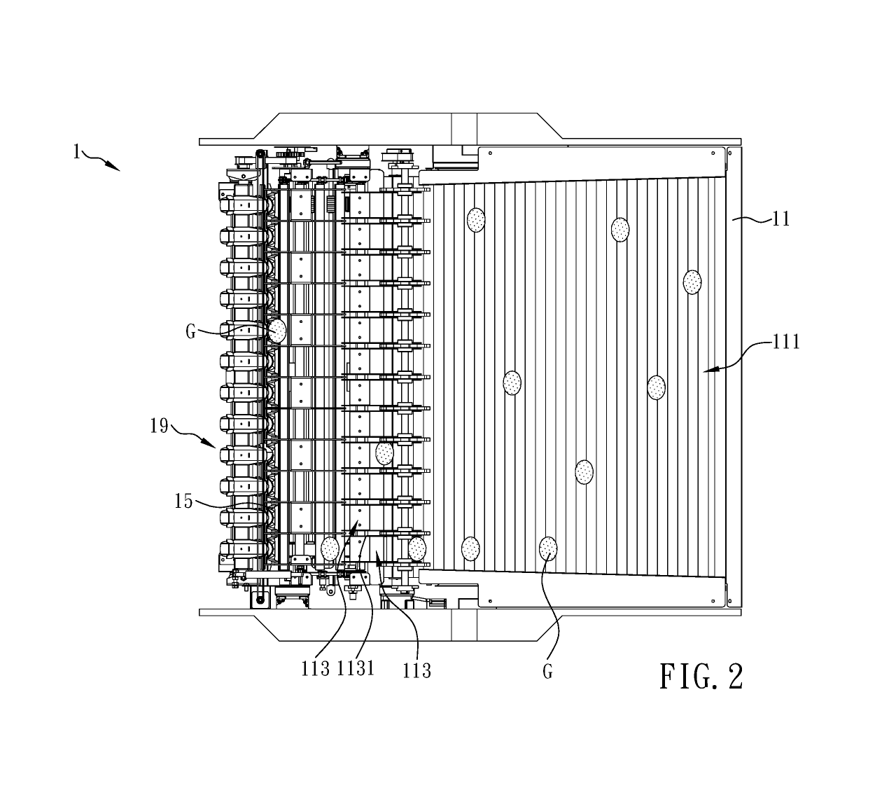

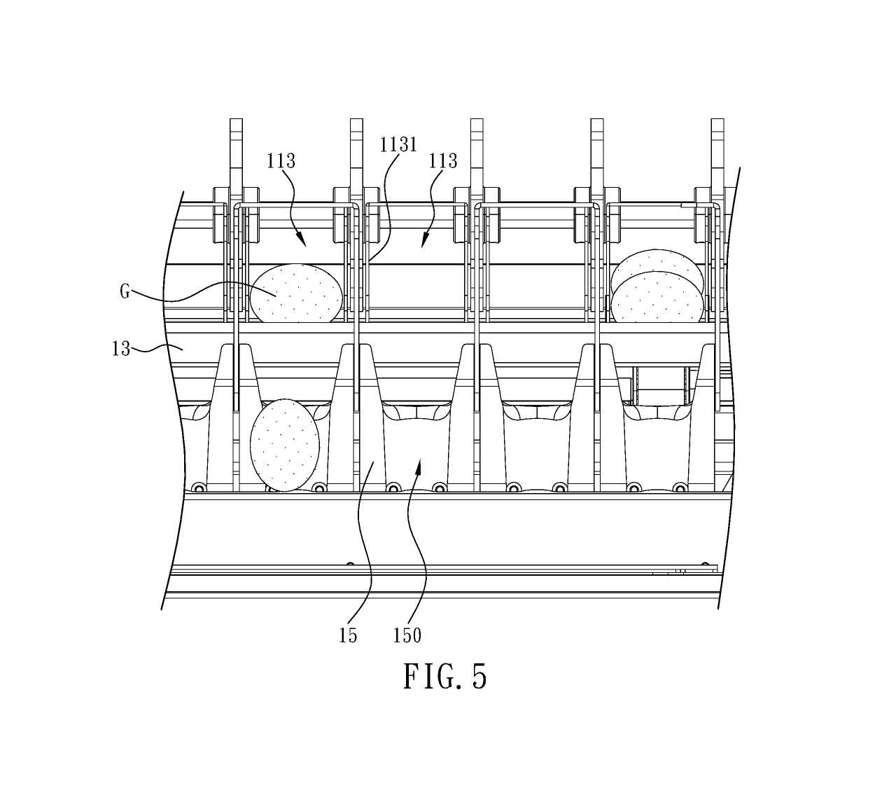

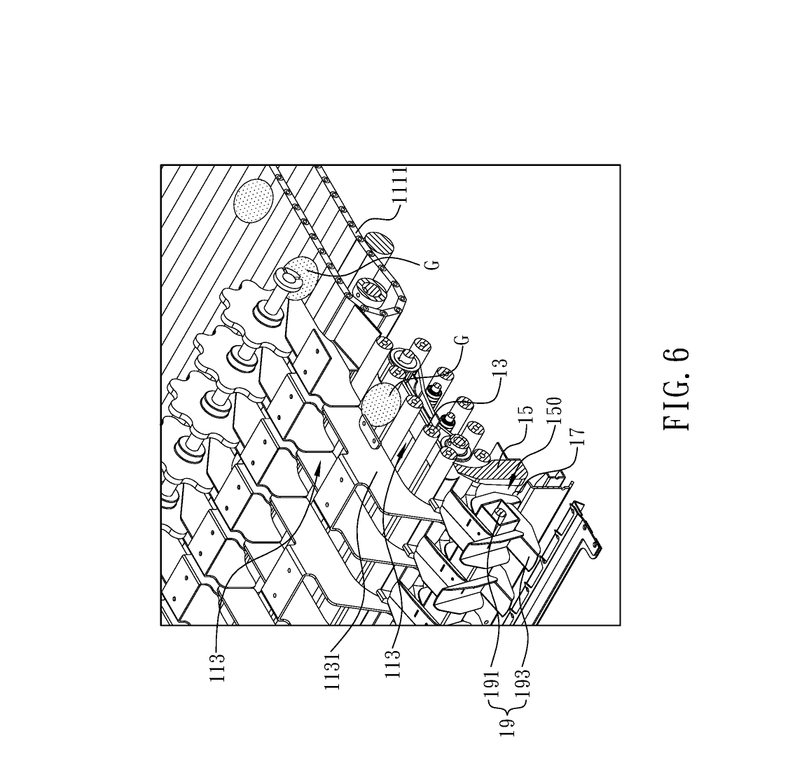

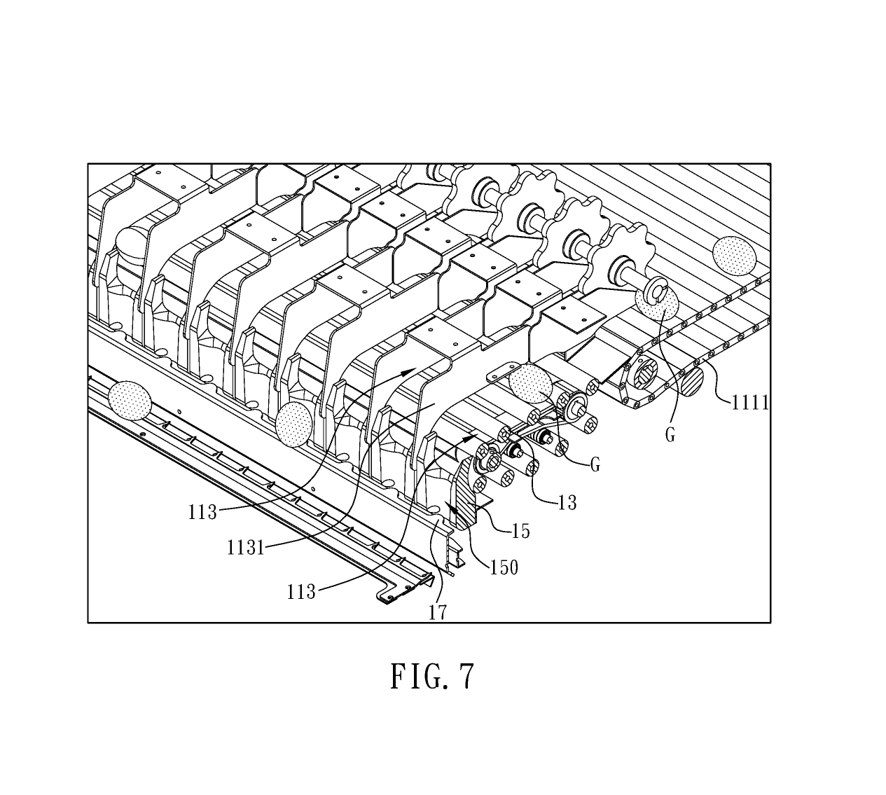

Referring to FIGS. 2 and 3-7, the orienting portions 15 are provided forward of the dividing areas 113, and each orienting portion 15 corresponds to a single dividing area 113. Each orienting portion 15 is provided therein with a fall space 150 that allows passage of eggs G in a downward direction. In a front view as shown in FIG. 5, each fall space 150 has a cross-sectional shape that is wider at the top than at the bottom, and the narrowest portion of the cross-sectional shape has a length in the left-right direction (i.e., a length in the transverse direction) that is less than the length of each egg G in the transverse orientation. When an egg G is conveyed from a dividing area 113 to the corresponding orienting portion 15, the egg G will be closer to one side (i.e., one of the left and right sides) of the orienting portion 15 than to the other side (i.e., the other of the left and right sides) of the orienting portion 15 because during the previous rolling process, the egg G has been shifted in position slightly toward its smaller end. When the egg G subsequently falls, it will be the smaller end of the egg G that contacts the inner wall surface of the orienting portion 15 first, and the smaller end will be hindered by the inner wall surface of the orienting portion 15 such that, while the egg G passes through the fall space 150, the position of the egg G is adjusted to a vertical orientation with the larger end facing down. In addition, to enhance the orienting effect of the orienting portions 15, the material of each orienting portion 15 in its entirety or at least the inner surface material of each orienting portion 15 can be a plastic material with a relatively high coefficient of friction. For example, the coefficient of static friction of the aforesaid material on the outer surface of the eggshell of an egg G is equal to or higher than 0.6 so as to increase the hindering force, to reduce the speed at which the smaller end of the egg G falls, and to thereby urge the egg G to turn steadily into the vertical orientation with the larger end facing down.

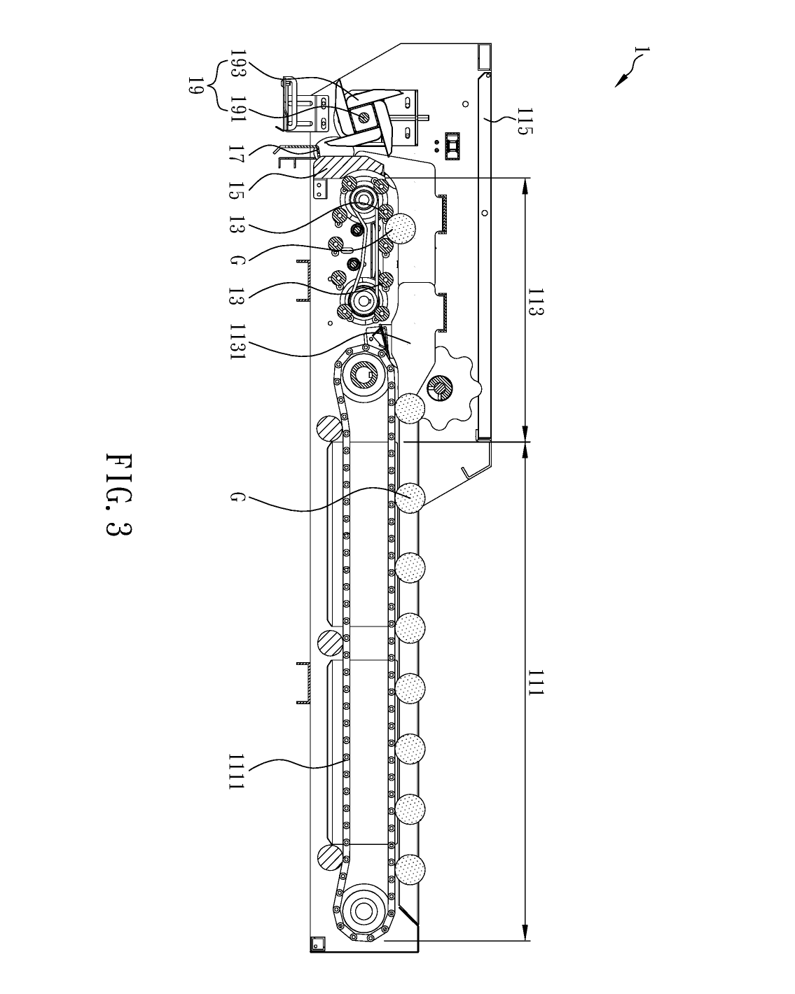

Referring to FIGS. 3, 6, and 7, each impact portion 17 is provided below a single orienting portion 15 and corresponds to the fall space 150 of the orienting portion 15. In certain embodiments, the impact portions 17 can be manufactured as portions of an integrally formed one-piece metal component. However, the present disclosure is not limited thereto, and in certain embodiments, the impact portions 17 are a plurality of elements independent from each other. When an egg G falls down from a fall space 150, the larger end of the egg G will hit the corresponding impact portion 17 such that the eggshell at the larger end of the egg G is cracked by an impact having the kinetic energy generated by gravitational acceleration. Thus, the egg processing apparatus 1 as a whole is structured in such a way that while an egg G is being moved and falling, the egg G is automatically adjusted to the vertical orientation with the larger end facing down and then has its eggshell cracked by an impact having the kinetic energy generated by the fall of the egg G itself, so that there is no need to crack the eggshell with an additional striking structure, effectively simplifying the equipment structure and reducing costs. The egg processing apparatus 1 is therefore suitable for use in an automated process flow or production line where it is required to process a large quantity of eggs G continuously.

Referring to FIGS. 1-3, 6 and 7, the egg processing apparatus 1 is further provided with at least one egg removing portion 19, and the egg removing portion 19 is provided forward of the impact portions 17. After an egg G falls down from a fall space 150 and hits the corresponding impact portion 17, the egg removing portion 19 moves the egg G away from its current position, i.e., away from the corresponding impact portion 17, to effectively prevent the next egg G falling down from hitting the previous egg G directly and from not hitting the corresponding impact portion 17 properly. This technical feature not only protects the eggshells of each two consecutive eggs G from unnecessary damage or being crushed by compression, but also ensures that each egg G will have its eggshell slightly cracked in a steady and individual manner. The egg removing portion 19 includes a rotating shaft 191 and at least one pushing member 193. The pushing members 193 can be directly or indirectly provided on the periphery, and around the circumference, of the rotating shaft 191 and can rotate along with the rotating shaft 191 to move into a space above the impact portions 17, thereby contacting the fallen and slightly cracked eggs G and pushing the eggs G out of their current positions. In certain embodiments, the egg removing portion 19 can adopt a structure different from that discussed above and carry out its removal function by any method such as by pushing, ejecting, vibrating, or blowing, as long as the egg removing portion 19 can move each egg G away from the corresponding impact portion 17.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An egg processing apparatus, comprising:
a machine body having an egg accommodating area and at least one dividing area located forward of the egg accommodating area, wherein each of the dividing areas is configured to receive at least one egg in succession from the egg accommodating area;
a plurality of conveying rollers located in the at least one dividing area, arranged at intervals along a rear-to-front direction, and configured to:
convey the at least one egg from a rear-side portion of the at least one dividing area to a front-side portion of the at least one dividing area; and
spin to drive the at least one egg in the at least one dividing area to rotate and to move along a direction toward a smaller end of the at least one egg;
at least one orienting portion located forward of the at least one dividing area, provided therein with a fall space, and configured to, through an inner wall surface of the at least one orienting portion, contact and hinder the smaller end of the at least one egg in the at least one orienting portion, and adjust a position of the at least one egg to a vertical orientation with its larger end facing down when the at least one egg passes through the fall space; and
at least one impact portion located below a corresponding one of the at least one orienting portion, corresponding to the fall space, and configured to be hit by the larger end of the at least one egg and crack an eggshell at the larger end of the at least one egg.

2. The egg processing apparatus according to claim 1, wherein the at least one dividing area is a plurality of dividing areas, and each two adjacent ones of the dividing areas are provided therebetween with at least one dividing wall.

3. The egg processing apparatus according to claim 1, wherein a length of an entrance of each of the at least one dividing area in a transverse direction is less than a total length of two adjacent eggs in a transverse orientation.

4. The egg processing apparatus according to claim 1, wherein an entirety or at least an inner surface of the at least one orienting portion is made of a plastic material with a high coefficient of friction, wherein the plastic material has a coefficient of static friction equal to or higher than 0.6 on an outer surface of the at least one egg.

5. The egg processing apparatus according to claim 1, wherein the at least one impact portion is made of a metal material.

6. The egg processing apparatus according to claim 1, wherein a top of a cross-sectional shape of the fall space is wider than a bottom of the cross-sectional shape.

7. The egg processing apparatus according to claim 6, wherein a narrowest portion of the cross-sectional shape has a length in a transverse direction that is less than a length of each of the at least one egg.

8. The egg processing apparatus according to claim 1, further comprising at least one egg removing portion, wherein the at least one egg removing portion is located forward of the at least one impact portion and configured to move the at least one egg away from the at least one impact portion.

9. The egg processing apparatus according to claim 8, wherein the egg removing portion comprises a rotating shaft and at least one pushing member, and the at least one pushing member is directly or indirectly provided on a periphery, and around a circumference, of the rotating shaft, and is configured to rotate along with the rotating shaft to move into a space above the at least one impact portion and push the at least one egg out of its position on the at least one impact portion.
